(19) United States
(12) Patent Application Publication
(10) Pub. No.: US 2005/0175162 A1
(43) Pub. Date: Aug. 11, 2005

(54) Request for e-mail information via telephone

(76) Inventor: Thomas Baumann, Holzkirchen (DE)

Correspondence Address: Siemens Corporation;Intellectual Property Department, 170 Wood Avenue South, Iselin, NJ, 08830, US

(21) Appl. No.: 10/515,202

(22) PCT Filed: May 13, 2003
(86) PCT No.: PCT/DE03/01665

(30) Foreign Application Priority Data
May 23, 2002 (DE) 102 22 876.0

(51) Int. Cl. H04M 11/00

(52) U.S. Cl. 379/100.08

(57) ABSTRACT

In the English translation document, please add the paragraph at page 17 line 1, after the newly added ABSTRACT section heading, as follows: The invention relates to a method and a control device for requesting e-mail related information from an e-mail server, using a telephone. An entry via the telephone prompts a connection between the control device and the e-mail server to be established and also the transmission of the requested information from the e-mail server to the control device, e.g. a media gateway controller. The requested information is transmitted to the telephone and displayed on the latter by the control device. The invention permits access to e-mail messages using various types of telephone, such as e.g. an analog telephone, an ISDN telephone and a mobile telephone. The availability of information in the form of e-mail is thus increased. The invention also permits more flexible access to e-mail information in situations where an internet terminal is lacking.

The invention relates to a method and a control device for requesting email-related information, which is stored in a server.

The convergence of different network technologies has resulted in new switching technology requirements, for example for the interworking of internet technologies and telephony.

The convergence or interworking of voice and data networks opens up new possibilities for services and service features.

A considerable amount of development work is currently being carried out with the aim of interfacing telecommunication terminals with data networks for packet-oriented voice transmission. There is a focus on the use of newly developed or correspondingly adapted protocols and hardware elements to provide switching resources to offer the transmission quality and service features known from conventional telecommunication networks (Time Division Multiplexing (TDM) networks).

Packet-oriented switching systems can be used to control voice transmission in the packet network. These are for example traditional switching systems, fitted with additional modules for signaling in the packet network. In the packet network the useful data stream is not generally routed via the switching center or the switching system as in TDM networks. The term “virtual trunking” is also used in this context. So-called soft switches are frequently used in the packet network with a view to this separation of the useful data stream and signaling. It is a network architecture in which two separate network elements are used. The control and signaling functions of traditional switching systems are taken over by so-called media gateway controllers. The useful data is routed via media gateways for example for adaptation at network interfaces. Media gateway controllers and media gateways communicate with each other using protocols such as the MGCP (Media Gateway Control Protocol), which was developed and standardized for this purpose (RFC 2705).

Protocols such as the SCTP (Stream Transmission Control Protocol) were developed for the transport of signaling messages across different networks, allowing the transmission of PSTN (Public Switched Network) signaling messages via IP (Internet Protocol) networks.

The object of the invention is to provide more flexible access to email-related information.

This object is achieved by the subject matter of claims 1 and 11.

With the inventive method for requesting email-related information, an input is made to request email-related information from a telecommunication terminal, which is connected directly or via an access network to a packet network. Said input prompts a control device to establish a connection via the packet network to the server, e.g. a mail server. The requested e-mail information is transmitted to the control device via the established packet network connection, for example using the SMTP (Simple Mail Transfer Protocol) or the POP (Post Office Protocol), and is then transmitted by the control device to the telecommunication terminal. The requested email-related information is finally displayed on a display unit of the telecommunication terminal. The email-related information is for example status information, such as the number of unread emails or the content or text of email messages. The control device can be a media gateway controller, e.g. if virtual trunking is practiced in the packet network, or even a conventional switching center (layer 5 switch), which supplies functions for signaling related to the packet network. The term “packet-oriented switching center” is used hereafter for devices with signaling functions for the packet network, in which signaling and useful data are not transmitted separately.

The invention allows an end user to request information about their email mailbox or emails simply and quickly. It is therefore not necessary to power up an internet terminal, e.g. a PC, to request received email messages. The solution is simple to implement on a media gateway controller or a packet-oriented switching system. The invention can be implemented purely on a software basis. The media gateway controller or packet-oriented switching system simply has to be provided with means for identifying messages, which are transmitted from a telephone for the purposes of requesting email-related information, and with means for establishing a connection for transmitting the requested information from the location or server where it is stored. The invention also increases flexibility in respect of access to email information, particularly since telephones alone are frequently available for making such requests rather than internet terminals, for example when traveling.

Telecommunication terminals, which do not support packet-based data traffic, can be connected to the packet network via an access network and exchange messages with the control device via a peripheral adapter or a switching center. Peripheral adapter here is used to mean the customer premises gateway. Examples of these are IADs (Integrated Access Devices) and MTAs (Multimedia Terminal Adapters). The access network operates for example using TDM (Time Division Multiplexing) technology and uses DSL (Digital Subscriber Line) technology for broadband access to useful data in the packet network (in some instances via a gateway for adaptation between the TDM network and the packet network).

In the case of a TDM-based access network, which accesses the packet network IPCore via a peripheral adapter, an analog telephone or ISDN (Integrated Services Digital Network) telephone can be used to request email-related information. FSK (Frequency Shift Key) signaling can be used for the exchange of messages between an analog telephone and a peripheral adapter in the context of the method. In the case of an ISDN telephone it is possible to exchange messages and control information for the email request with the peripheral adapter using the DSS1 (Digital Signal Standard No. 1) protocol—reference is frequently made in this context to D channel signaling. The same protocols can also be used for the exchange of messages or control information between the telecommunication terminal and a switching center.

For communication between a peripheral adapter and the control device, the MGCP protocol can be used with analog terminals or the SCTP (Stream Control Transfer Protocol) for ISDN terminals. For communication between a switching center and the control device, the ISUP (ISDN User Part) protocol can be used in the context of SS7 (Signaling System No. 7) signaling. The invention has the advantage that the widest range of telecommunication terminals can be used to request emails. Deployment of the technologies and protocols used for the request or for the transmission of information can be organized transparently for the service user. Different telecommunication terminal types and links can be configured for standard service features and service control when emails are requested by the service user. In addition to conventional telecommunication terminals, as used in TDM networks, telecommunication terminals can also be used, which support a direct link to the packet-based network. Examples are IP telephones, i.e. telephones which allow voice transmission via an IP network (Voice-over-IP) or PDAs (Personal Digital Assistants), which are connected via a wireless LAN (Local Area Network) interface to the packet network. The MGCP protocol for example can then be used as the protocol for communication with the control device.

The request can also be initiated from a mobile telephone via a switching center, which supports telephony with mobile telephones. This switching center communicates with the control device, for example using SS7 protocols. The BSSAP (Base Station Application Part) protocol can be used between the telecommunication terminal and the switching center, which supports telephony with mobile telephones.

The subject matter of the invention is described in more detail below in the context of an exemplary embodiment with reference to Figures, in which:

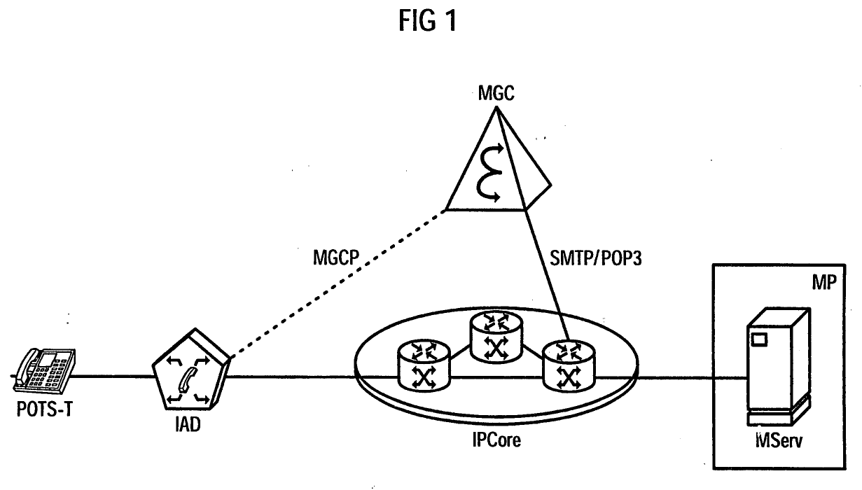

FIG. 1: shows a system for the inventive email request using an analog telephone linked to a packet-oriented network via a peripheral adapter,

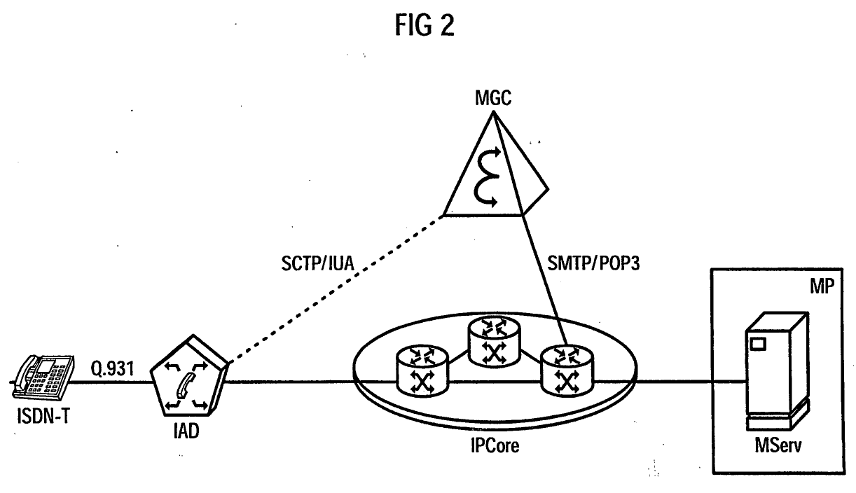

FIG. 2: shows a system for the inventive email request using an ISDN telephone linked to a packet-oriented network via a peripheral adapter,

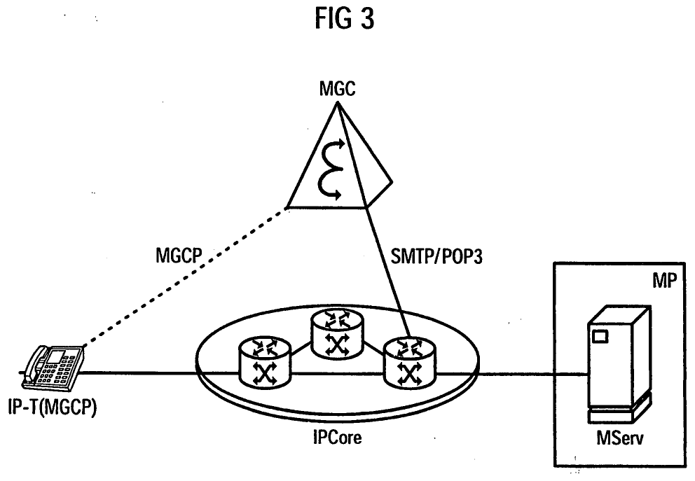

FIG. 3: shows a system for the inventive email request using an IP telephone,

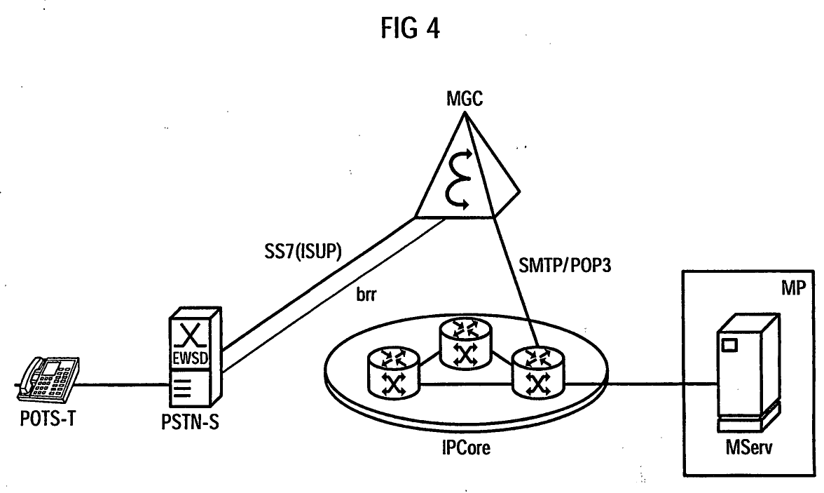

FIG. 4: shows a system for the inventive email request using an analog telephone linked to a packet-oriented network via a TDM switching center,

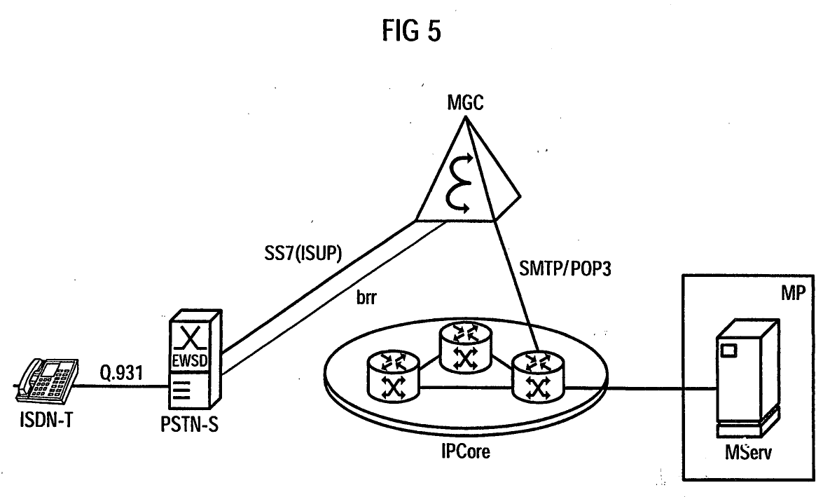

FIG. 5: shows a system for the inventive email request using an ISDN telephone linked to a packet-oriented network via a TDM switching center,

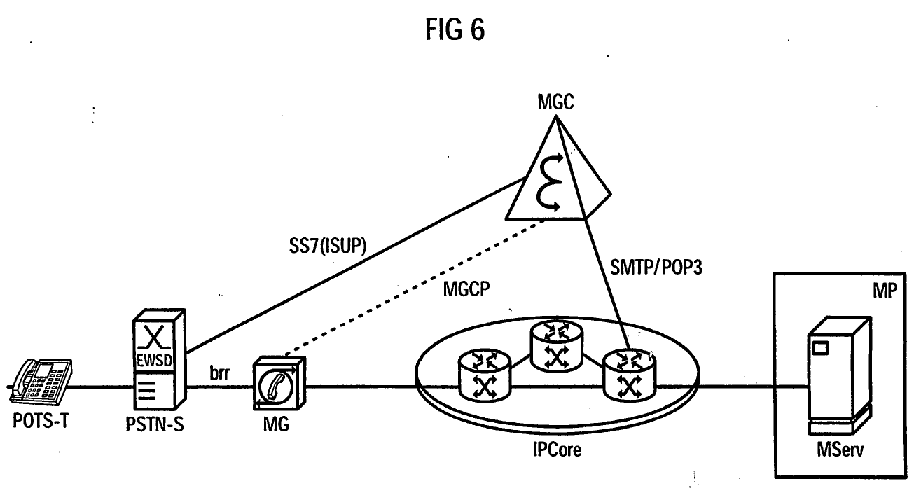

FIG. 6: shows a system for the inventive email request using an analog telephone linked to a packet-oriented network via a TDM switching center and a media gateway,

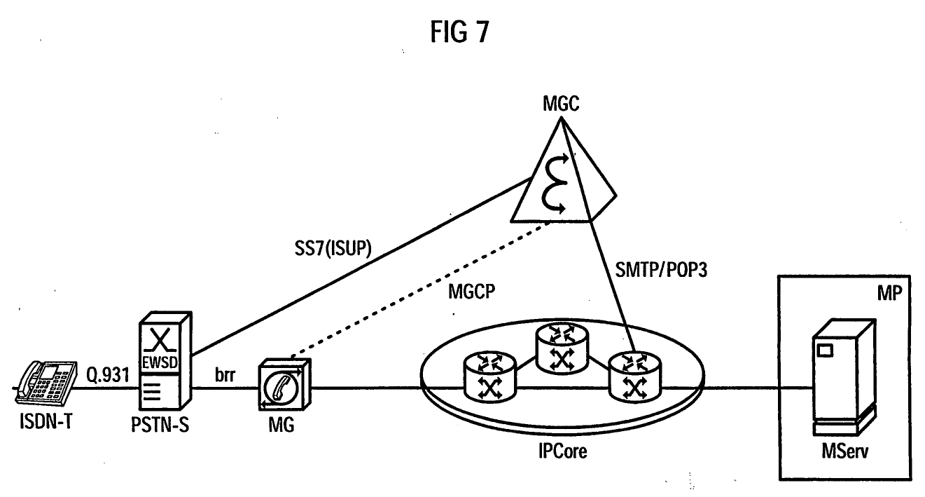

FIG. 7: shows a system for the inventive email request using an ISDN telephone linked to a packet-oriented network via a TDM switching center and a media gateway,

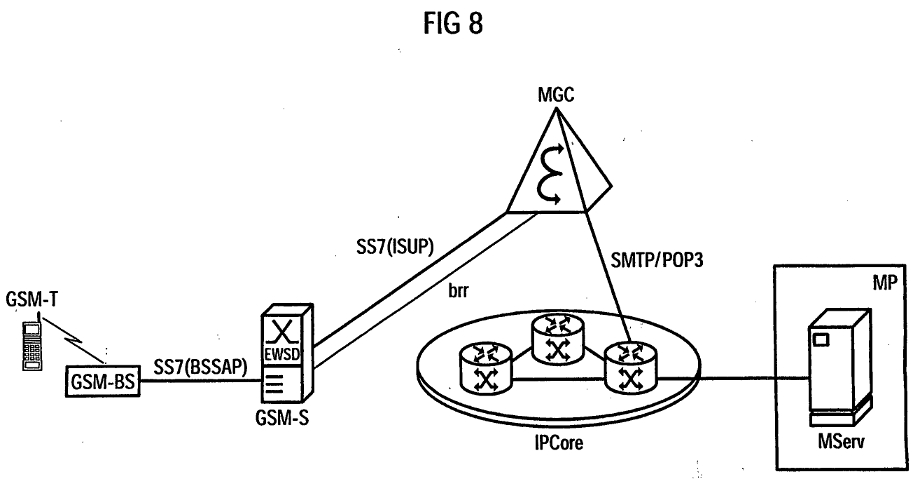

FIG. 8: shows a system for the inventive email request using a mobile telephone.

The same reference characters thereby refer to the same elements.

FIGS. 1 to 8 show different constellations, in which the invention can be used. An inventive method for requesting status information for an email account from a service provider SP and the content or text of received email messages is shown below with reference to FIG. 1. For the further constellations 2 to 8, changes or differences in respect of the inventive method in FIG. 1 are described for the respective constellation.

FIG. 1 shows a system for an inventive request for email-related information using an analog telephone ISDN-T. The analog telephone ISDN-T is connected via an access network, operated for example using Voice-over-DSL technology, using an IAD (Integrated Access Device) to a packet-based network IPCore. The packet-based network is for example an IP network (IP: Internet Protocol) or an ATM network (ATM: Asynchronous Transfer Mode). The IAD can exchange signaling messages with a media gateway controller MGC using the MGCP protocol MGCP. According to the invention the media gateway controller MGC accesses a mail server Mserv, whereby for example the SMTP (Simple Mail Transfer Protocol) according to the standard IETF RFC821 or the POP3 (Post Office Protocol version 3) according to the standard IETF RFC1939 is used.

An inventive request for email status information and the content of received email messages then proceeds as follows: The end user picks up the handset of the analog telephone POTS-T and dials a special code for requesting emails, for example “4711”. Signaling information is transmitted on the basis of this input via the access network and the IAD to the media gateway controller, as a result of which a request for email status is prompted using the SMTP protocol or the POP3 protocol. The media gateway controller MGC transmits the requested email status information, e.g. the number of unread emails, to the IAD as ASCII text using the MGCP protocol. The control command “RequestNotification” can for example be used for the transfer of the text. This control command is specified in IETF RFC2705, which describes the MGCP protocol. A line package can be transmitted using RequestNotification. According to IETF RFC2705 packages are used to transmit events and actions, in other words to initiate and control events. The line package contains a parameter adsi (Analog Display Service Interface), which can have a string as its value. According to the invention this string contains email status information or text from an email message. On receipt of the email status information, the IAD sends said information using FSK (Frequency Shift Key) signaling, as defined in the standard ETSI-ETS300659, to the analog telephone ISDN-T. On receipt of the status information, in other words for example the number of unread emails, the end user can press the “*” key again, whereupon the title and sender of the most recent unread email are displayed as ASCII text. This information is transported in the same way as the request for email status information, i.e. using the MGCP protocol or FSK signaling. By pressing the “*” key again the end user is able to see the title and sender of the next unread email displayed in text form. When there are no more unread emails, the titles and senders of the read emails are displayed. A number is output before the title and sender of the respective email, which the end user can use to refer to said email later. If when the “*” key is next pressed, there are no more emails, the text “no more emails” will be displayed. If the end user then presses a digit sequence followed by the “*” key, e.g. “1*”, whereby the digit sequence refers to the required email, the text of the corresponding email is displayed. As the display unit of the analog telephone cannot generally display the entire text, it is displayed on the telephone as scrolling text. Alternatively the media gateway controller MGC only sends the number of characters that can be displayed on the display unit and the end user presses the “*” key repeatedly to request further characters. If the end user presses the “#” key, the display of the respective email is canceled and the end user can request the next email. The end user terminates the email request by replacing the handset. The transport of static information or emails in ASCI format is thereby always effected by means of a corresponding request to the media gateway controller via the IAD using the MGCP protocol. The media gateway controller then uses an appropriate protocol such as SMTP or POP3 to request the required information from the server Mserv and transmits it back to the analog telephone PSTN-T.

FIG. 2 shows the inventive system for a request via an ISDN telephone ISDN-T. The request differs from the request using an analog telephone POTS-T in the following details relating to the transport protocol. Email information or email status information is transported between the terminal (ISDN telephone ISDN-T) and the IAD in the context of D channel signaling. The progress report, as defined in the ITU standard Q.931 (ISDN user network interface layer 3 specification for basic call) is used for this. For this message according to the ITU standard Q.957.1 (User-to-user signaling) a user-to-user information element defined in the ITU standard Q.931 is provided, which allows the transport of strings. The Stream Control Transmission Protocol (SCTP), as defined in the IETF RFC 2960, is used between the IAD and the media gateway controller MGC. This protocol operates with the ISDN User Adaption Layer (IUA), as defined in the standard IETF RFC 3057, to transmit ISDN signaling messages.

FIG. 3 shows an IP telephone IP-T(MGCP), which supports the MGCP protocol. This telephone IP-T(MGCP) is linked directly to the packet network or packet-based long-range network IPCore. Instead of an IP telephone a Personal Digital Assistant (PDA) can also be used, which is connected via a mobile LAN interface to the IP network or packet network IPCore and which supports the MGCP protocol. The mail text can be displayed simply and in a user-friendly manner on the large display of this PDA.

FIGS. 4 and 6 show an analog telephone POTS-T, via which email messages can be requested. The analog telephone POTS-T is thereby linked via a switching center of the TDM network PSTN-S (PSTS-S: PSTN switch), e.g. a private branch exchange or a switching system. Email status information or the content of email messages is transported from the media gateway controller MGC to the switching center PSTN-S using SS7 (Signaling System No. 7) signaling. The user-to-user information parameter of the user-to-user information message (USR) can for example be used for this purpose. The corresponding definitions and functional relationships are set out in the ITU standards Q.762 (ISDN user part general functions of messages and signals), Q.763 (ISDN user part formats and codes) and Q.737.1 (User-to-user signaling). The switching center PSTN-S then transports the email-related information via FSK signaling to the terminal POTS-T. Control signals input by the user, e.g. “*” or “#” are detected differently depending on the transmission of the useful data brr (brr stands for bearer).
When the useful data is transmitted via a PSTN network to the media gateway controller MGC (FIG. 4), the Intelligent Network (IN) function “user interactive dialogue” can be used. Details are given in the ITU standard Q.1601 (Signaling system no. 7—Interaction between N-ISDN and INAP CS2). Input can then be transmitted to the media gateway controller MGC and can be detected there by means of a so-called Specialized Resource Function (SRF), which can be provided for intelligent networks according to the ITU standard Q.1224 (Distributed functional plan for intelligent network capabilities set 2).
The useful data and the bearer brr are frequently transmitted separately from the signaling via the packet network IPCore. The term virtual trunking is also used in this context. The useful data is then adapted in a media gateway MG after the transition between the PSTN network and the packet network IPCore. The input can then be detected or identified in the media gateway MG and notification of it can be given to the media gateway controller MGC using the MGCP protocol.

The constellations for an ISDN telephone ISDN-T corresponding to the constellations in FIGS. 4 and 6 are shown in FIGS. 5 and 7. The descriptions above for FIGS. 4 and 6 relating to the routing of useful data and identification of user input also apply here. Similarly email-related information can also be transmitted from the media gateway controller MGC to the switching center PSTN-S using the ISDN User Part (ISUP) message user-to-user information message. One difference compared with the analog telephone lies in the transport of the email-related messages to the terminal ISDN-T. This is achieved in the same way as in FIG. 2 via the D channel, e.g. using the user-to-user information element of a PROGRESS message.

FIG. 8 shows the request for email status information or the content of email messages using a mobile telephone GSM-T, for example a GSM (Global System for Mobile Communications) mobile telephone. The mobile terminal GSM-T is used to transmit messages to a base station GSM-B (GSM-BS: GSM Base Station). Signaling messages can be transmitted to a switching center GSM-S by means of SS7 signaling using the Base Station User Part (BSSAP) defined in the GSM standard. The transmission of messages or signaling between the switching center GSM-S is effected using SS7 signaling as in FIGS. 4 and 5. Alternatively the bearer could also be routed via a media gateway separately from the signaling, as shown in FIGS. 6 and 7 for fixed network telephones (not shown as a Figure for the mobile telephone). The exchange of information between the switching center GSM-S and media gateway controller MGC or media gateway as well as media gateway controller MGC and media gateway could then be carried out according to the functions and protocols specified for FIGS. 6 and 7. In both cases email messages or email status information can be transported from the switching center GSM-S to the mobile terminal GSM-T as SMS (Short Message Service) messages.

The user input at the mobile telephone GSM-T for controlling the email request can for example be effected using the GSM feature Subscriber Controlled Input (SCI). This input is then transmitted to the switching center GSM-S using the BSSAP and from there using ISUP to the media gateway controller MGC.

1.-14. (canceled)

15. A method for requesting email-related information stored in a server, the method comprising:
initiating a request for email-related information by an input at a telephone linked directly or via an access network to a packet network, wherein a media gateway controller is prompted by the input to establish a connection to the server via the packet network;
transmitting the requested email-related information to the media gateway controller via the established packet network connection;
transmitting the requested email-related information by the media gateway controller to the telephone; and
displaying the requested email-related information on a display unit of the telephone.

16. The method according to claim 15, wherein the telephone is an analog telephone, an ISDN telephone, an IP telephone, a PDA or a mobile telephone.

17. The method according to claim 15, wherein the email-related information is in the form of email status information or the content of an email message.

18. The method according to claim 16, wherein the email-related information is in the form of email status information or the content of an email message.

19. The method according to claim 15, wherein the email-related information is transmitted from the server to the media gateway controller using the SMTP or POP protocol.

20. The method according to claim 16, wherein the email-related information is transmitted from the server to the media gateway controller using the SMTP or POP protocol.

21. The method according to claim 17, wherein the email-related information is transmitted from the server to the media gateway controller using the SMTP or POP protocol.

22. The method according to claim 15, wherein
the telephone accesses the packet network via an access network, and wherein
the telephone exchanges messages with the media gateway controller using a peripheral adapter or a switching center.

23. The method according to claim 16, wherein
the telephone accesses the packet network via an access network, and wherein
the telephone exchanges messages with the media gateway controller using a peripheral adapter or a switching center.

24. The method according to claim 17, wherein
the telephone accesses the packet network via an access network, and wherein
the telephone exchanges messages with the media gateway controller using a peripheral adapter or a switching center.

25. The method according to claim 22, wherein
the telephone accesses the packet network via a Time Division Multiplexing (TDM) based access network, and wherein
either
an analog telephone is used as the telephone, and Frequency Key Shift (FSK) signaling is used between the telephone and the peripheral adapter or the switching center, or
an ISDN telephone is used as the telephone and the Digital Signal Standard No.1 (DSS1) protocol is used between the telephone and the peripheral adapter.

26. The method according to claim 22, wherein the Stream Control Transfer Protocol (SCTP) is used between the peripheral adapter and the media gateway controller.

27. The method according to claim 25, wherein the Stream Control Transfer Protocol (SCTP) is used between the peripheral adapter and the media gateway controller.

28. The method according to claim 26, wherein the Stream Control Transfer Protocol (SCTP) transports Digital Signal Standard No.1 (DSS1) messages from the telephone via the packet network to the media gateway controller using ISDN User Adaption.

29. The method according to claim 22, wherein the ISUP (ISDN User Part) protocol is used between the switching center and the media gateway controller.

30. The method according to claim 15, wherein
an IP telephone or a PDA is used as the telephone, wherein
the telephone communicates with the media gateway controller by a direct connection via the packet network, and wherein
the Media Gateway Control Protocol (MGCP) is used for communication between the telephone and the media gateway controller.

31. The method according to claim 15, wherein
a mobile telephone is used as the telephone, wherein
the mobile telephone communicates with the media gateway controller via a switching center supporting telephony with mobile telephones, and wherein
the Base Station Application Part (BSSAP) protocol is used between the telephone and the switching center.

32. A media gateway controller, comprising:
a mechanism for identifying messages transmitted to request email-related information, wherein the request is initiated by a telephone; and
a mechanism for establishing a connection for transmitting email-related information or for transmitting a request for email-related information from a server to the media gateway controller in accordance with a transmitted message.

33. A media gateway controller for faciliating a method for requesting email-related information stored in a server, the method comprising:
initiating a request for email-related information by an input at a telephone linked directly or via an access network to a packet network, wherein a media gateway controller is prompted by the input to establish a connection to the server via the packet network;
transmitting the requested email-related information to the media gateway controller via the established packet network connection;
transmitting the requested email-related information by the media gateway controller to the telephone; and
displaying the requested email-related information on a display unit of the telephone, wherein
the media gateway controller comprises:
a mechanism for identifying messages transmitted to request email-related information, wherein the request is initiated by a telephone; and
a mechanism for establishing a connection for transmitting email-related information or for transmitting a request for email-related information from a server to the media gateway controller in accordance with a transmitted message.
